(19) United States
(12) Patent Application Publication
(10) Pub. No.: US 2025/0166429 A1
(43) Pub. Date: May 22, 2025

(54) SYSTEMS, METHODS, AND DEVICES FOR GRAPHICAL USER INTERFACES

(71) Applicant: Fisker Inc., Manhattan Beach, CA (US)

(72) Inventors: Todd Omotani, Manhattan Beach, CA (US); Jyoteen Majmudar, Manhattan Beach, CA (US)

(21) Appl. No.: 18/834,933

(22) PCT Filed: Jan. 31, 2023
(86) PCT No.: PCT/US2023/061629

§ 371 Date: Jul. 31, 2024

Related U.S. Application Data
(60) Provisional application No. 63/305,046, filed on Jan. 31, 2022.

(51) Int. Cl. G07C 5/06; G06F 9/451; G07C 5/08

(52) U.S. Cl. CPC G07C 5/06; G06F 9/451; G07C 5/0833

(57) ABSTRACT

Exemplary disclosed embodiments include systems, methods, and devices for graphical, aural, and tactile user interfaces. The systems, methods, and devices may include one or more computer hardware processors in communication with a non-transitory computer storage medium, and the one or more computer hardware processors may be configured to execute the computer-executable instructions including, for example, receiving one or more input associated with an energy usage of a vehicle, determining a power consumption of the vehicle based on the input; and displaying a ripple on the screen based on the power consumption. In some embodiments, a sound may be generated for the user to indicate a change in a vehicle's condition.

This application claims the benefit of priority of U.S. Provisional Application No. 63/305,046, filed Jan. 31, 2022, the contents of which is incorporated by reference herein in its entirety.

### FIELD OF THE DISCLOSURE

The present disclosure relates to systems, methods, and devices for graphical, aural, and tactile and other user interfaces for vehicles. Specifically, interfaces of the present disclosure can enhance the electric vehicle driving experience.

### BACKGROUND

Graphical user interfaces are used for various applications to alert, warn, and convey information to users. For known graphical user interfaces, different techniques are used to convey information quickly and efficiently such as bar graphs or an increasing number.

In vehicles, for example including electric and autonomous vehicles, substantial information might be conveyed to a user all at once. It is desirable for a graphical under interface to display information in a readily understood manner that does not impose substantial cognitive load or unduly distract the driver from operating a vehicle. Graphical user interfaces and related systems and methods disclosed herein use, for example, visual, aural, tactile stimuli, in an aesthetically pleasing way, to convey information to the user quickly and efficiently.

In particular, vehicles receiving propulsion from electric motors require special consideration because of the lack of sound (e.g., engine sound), haptics (e.g., rumble of a reciprocating engine), and visual input (e.g., revolutions-per-minute, etc.) associated with gearboxes or other types of motor such as internal combustion engines. With improved graphical, aural, and tactile user interfaces, such as those disclosed herein, the user can receive audio, visual, and even tactile sensations to indicate movement of a vehicle, battery use, and acceleration, among other characteristics.

### SUMMARY

In the following description, certain aspects and embodiments will become evident. It is contemplated that the aspects and embodiments, in their broadest sense, could be practiced without having one or more features of these aspects and embodiments. It is also contemplated that these aspects and embodiments are merely exemplary.

Exemplary disclosed embodiments include systems, methods, and devices for graphical, aural, and tactile user interfaces. For example, in some embodiments, a non-transitory computer storage medium may be configured to store computer-executable instructions. The system may include one or more computer hardware processors in communication with the non-transitory computer storage medium, the one or more computer hardware processors configured to execute the computer-executable instructions. The instructions, for example, may include receiving one or more input associated with an energy usage of a vehicle, determining a power consumption of the vehicle based on the input; and displaying a ripple on the screen. In some embodiments, a sound may be generated for the user to indicate a change in a vehicle's condition.

One or more characteristics of a vehicle illustrated by a ripple may include vehicle speed, vehicle acceleration, regenerative braking, a threshold speed, a power consumption, an efficiency of the electric motor, or similar. In some embodiments, instructions may further comprise displaying directions associated with a navigation system and/or displaying a state of a transmission of the vehicle. In some embodiments, amplitude of a ripple can be based on vehicle characteristics and frequency of a ripple can be based on power consumption. In some embodiments, a ripple can be displayed at an angle. In some embodiments, screen may be associated with an instrument cluster. In some embodiments, displaying power consumption may occur on a heads-up-display.

It is to be understood that both the foregoing general description and the following detailed description are exemplary and explanatory only and are not restrictive of the invention. The accompanying drawings, which are incorporated in and constitute a part of this specification, illustrate several exemplary embodiments and together with the description, serve to outline principles of the exemplary embodiments.

### BRIEF DESCRIPTION OF THE DRAWINGS

FIG. 1 depicts a graphical user interface consistent with disclosed embodiments.

FIGS. 2A-2D depict graphical user interfaces consistent with disclosed embodiments.

FIGS. 3A-3J depict graphical user interfaces consistent with disclosed embodiments.

FIG. 4 depicts a graphical user interface consistent with disclosed embodiments.

### DESCRIPTION OF EXEMPLARY EMBODIMENTS

Reference will now be made in detail to exemplary embodiments, shown in the accompanying drawings.

Exemplary disclosed embodiments include systems, methods, and devices for graphical, aural, and tactile user interfaces. For example, in some embodiments, non-transitory computer storage medium can be configured to store computer-executable instructions. The system can include one or more computer hardware processors in communication with non-transitory computer storage medium, and one or more computer hardware processors configured to execute computer-executable instructions. Instructions, for example, can include receiving one or more input associated with an energy usage of a vehicle, determining power consumption of vehicle based on input; and displaying a ripple on screen based on power consumption.

Ripple, as used herein, can be a real-time visual interface that indicates one or more characteristics of vehicle. One or more characteristics of vehicle can include vehicle speed, vehicle acceleration, regenerative braking, a threshold speed, an efficiency of the electric motor, or similar. In some embodiments, instructions further comprise displaying directions associated with navigation system and/or displaying state of drive system of vehicle. For example, states of drive system can include forward, reverse, sport, economy, and/or reflect a low or high torque setting. In some embodiments, amplitude of ripple can be based on accessory use and frequency of ripple can based on motor use. In some embodiments, ripple may be displayed at an angle. In some embodiments, screen may be associated with instrument cluster. In some embodiments, displaying power consumption may occur on heads-up-display. In some embodiments, sound may be generated to indicate to user a characteristic of or change in vehicle's condition.

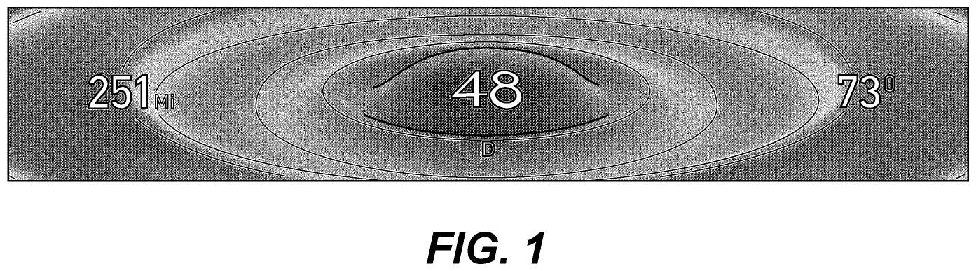

FIG. 1 shows an exemplary graphical user interface. The graphical user interface can display ripple associated with energy usage of vehicle. Ripple may be based on input associated with energy usage of the vehicle. Input can be configured into a sinusoidal equation to determine graph. The graph can represent a three-dimensional visualization on two-dimensional screen. In the three-dimensional visualization, the graph may represent the sinusoidal equation in concentric circles or other shapes such as squares, octagons, etc. Input can be how quickly energy is consumed, acceleration, speed, use of accessories, environmental conditions, or environmental control system. An exemplary sinusoidal equation is:

$$y = sin ( ( i ( u * v ) - ( a * t ) ) * b * π ) * c ) \qquad ( 1 )$$

where, i is a positive or negative number to control direction of ripple travel. Positive or negative number i can be based on whether vehicle is discharging (e.g., positive number, outward-moving ripples) or charging (e.g., negative number, inward-moving ripples). In equation (1), u can be a horizontal plane, v can be vertical plane, a can be integer that controls speed of the ripple, t can be time, b can be a measure of how quickly energy is being consumed by vehicle, and c can be amplitude of ripple.

For example, u and v may alone, or together, describe (e.g., dress) how ripple lays on surface and/or represents the surface. In some embodiments, factor b can be based on rate of battery depletion or change, or state of charge of battery. In some embodiments, factor b can be based on power consumption of vehicle based on use of one or more vehicle motor or accessories (e.g., powered devices integrated into or plugged into the vehicle such as radio, vehicles signals or lights, displays, interior lighting, fans, or similar). In some embodiments, factor c can be based on vehicle characteristics (e.g., vehicle speed, vehicle acceleration, regenerative braking, a threshold speed, an efficiency). In some embodiments, t can represent time from origin of wave to destination (e.g., edge of screen). For example, t may be one second.

An exemplary equation (1) for sine wave is shown; cosine wave can be used. Other waves and other mathematical relations can be used such as modified sine wave.

Another aspect of present disclosure relates to audio feedback to user of vehicle. Audio feedback includes sound that acts as one information layer of potentially several information layers, where display may act as another information layer of several information layers. For example, audio feedback may support sensory feedback from display. One or more speakers of vehicle may supply audio feedback to user and/or environment outside vehicle.

In some embodiments, audio feedback may include one or more sounds that synthesize acoustic qualities such as repetition of sounds, frequency of sounds, or increase or decrease in sound. For example, acoustic qualities may represent that of internal combustion engine. Audio feedback can include musical characteristics or constraints (e.g., beats in a measure, beats per minute, pitch, tone, notes). In some embodiments, sounds of audio feedback may be organized into tempo grid such that increasingly smaller musical subdivisions are placed on repeating sounds that map to thresholds in vehicle's decreasing or increasing velocity. Such an arrangement may give user an impression of internal combustion engine translated into a musical arrangement. Audio feedback can include pitches of sounds that rise with velocity and acceleration. Audio feedback can include pitches of sounds that fall with velocity and acceleration. The audio feedback can brighten and increase energy (e.g., frequency) to indicate increasing speed or increasing torque generated by vehicle. Audio feedback can darken and decrease energy (e.g., frequency) to indicate decreasing speed or decreasing torque generated by the vehicle.

FIG. 1 illustrates an exemplary aspect of a sinusoidal wave consistent with the present disclosure. Sinusoidal wave can be displayed on screen of vehicle. Screen can be configured to display numbered or graphical elements consistent with one or more states of vehicle or environment, such as distance left to travel before charge is depleted, speed of the vehicle, temperature of the environment, or transmission state of vehicle (e.g., drive, reverse, neutral, park). For example, screen can display speed of vehicle as numerical figure and sinusoidal wave based on energy usage of vehicle.

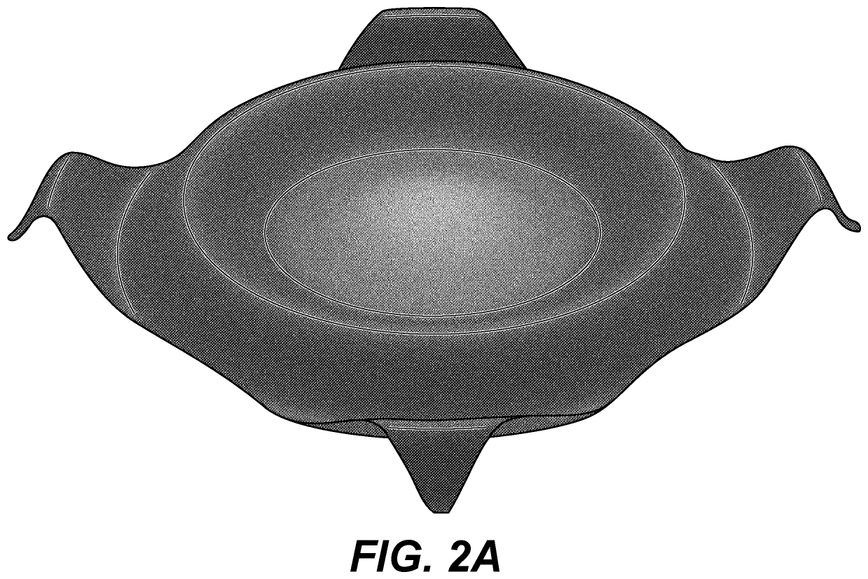

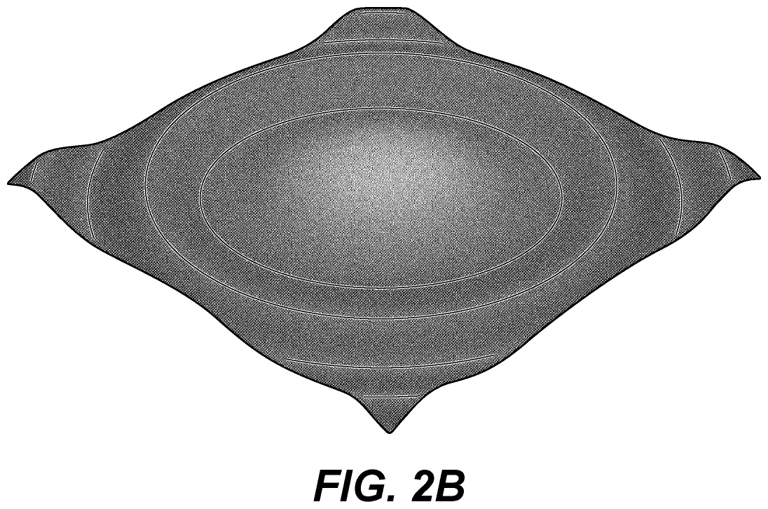

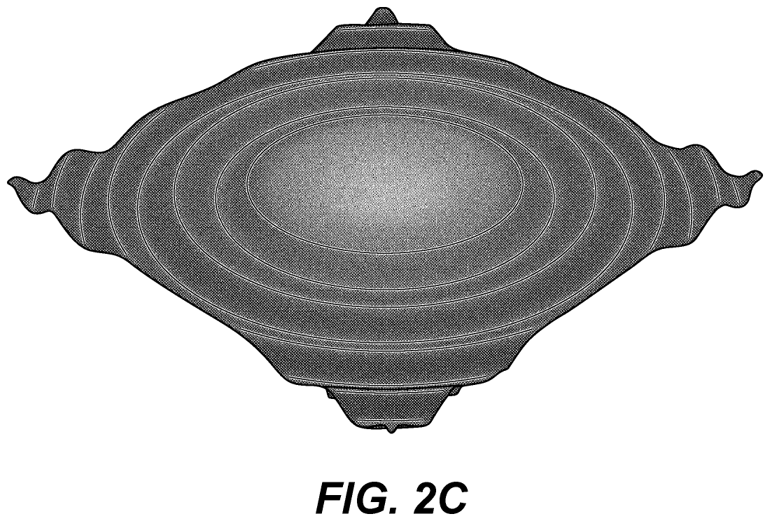

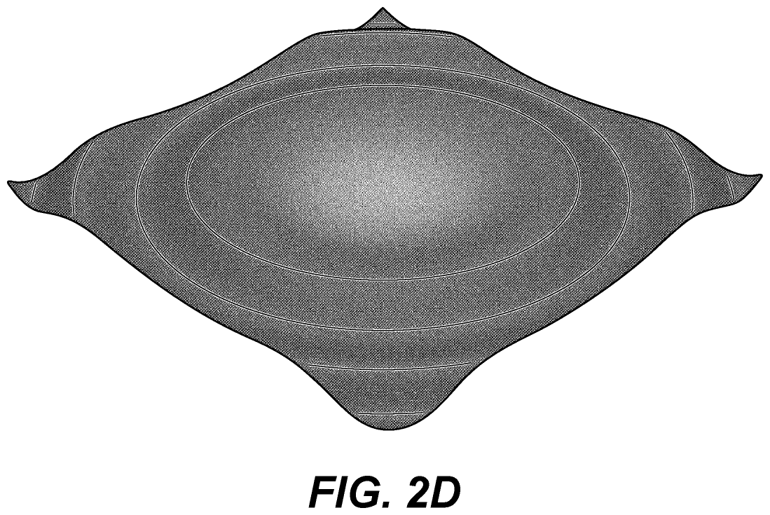

FIGS. 2A-2D illustrate exemplary aspects of sinusoidal waves consistent with the present disclosure. FIG. 2A illustrates sinusoidal wave with relatively large amplitude and relatively low frequency. In some embodiments, relatively large amplitude can be based on relatively high vehicle characteristic. In some embodiments, relatively low frequency can be based on relatively low use of power for accessories or relatively low use of power by vehicle motor. A relatively large amplitude with a relatively low frequency may occur, for example, when coasting at high speed.

FIG. 2B illustrates a sinusoidal wave with relatively small amplitude and relatively low frequency. In some embodiments, relatively small amplitude may be based on relatively low vehicle characteristic. In some embodiments, relatively low frequency may be based on relatively low use of power for accessories or relatively low use of power by vehicle motor. A relatively small amplitude with a relatively low frequency may occur when coasting to a stop.

FIG. 2C illustrates sinusoidal wave with relatively small amplitude and relatively high frequency. In some embodiments, relatively small amplitude can be based on relatively high vehicle characteristic. In some embodiments, high frequency may be based on relatively high use of power for accessories or relatively high use of power by vehicle motor. A relatively small amplitude with a relatively high frequency may occur when accelerating from a stop.

FIG. 2D illustrates a sinusoidal wave with relatively large amplitude and relatively high frequency. In some embodiments, relatively large amplitude can be based on relatively high vehicle characteristic. In some embodiments, relatively high frequency can be based on relatively high use of power for accessories or relatively high use of power by vehicle motor. A relatively high amplitude with a high frequency may occur when accelerating at high speeds or traveling at high speeds with high accessory use of a fan.

The sinusoidal wave of the ripple improves the way the graphical user interface communicates to the user how power consumption relates to vehicle characteristics. This allows the user to perceive the difference in vehicle characteristics effecting power consumption by comparing the ripple in similar scenarios. This creates an intuitive association that enables the user to improve efficiency.

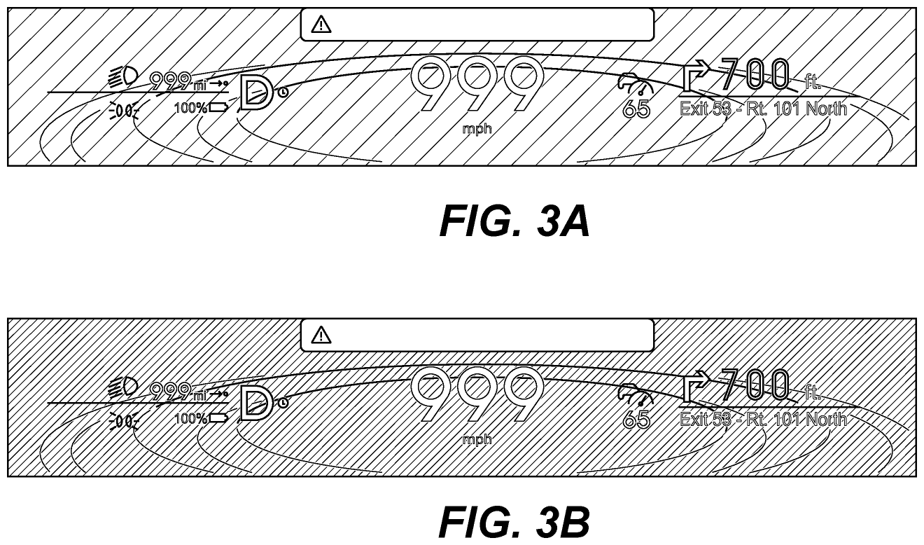

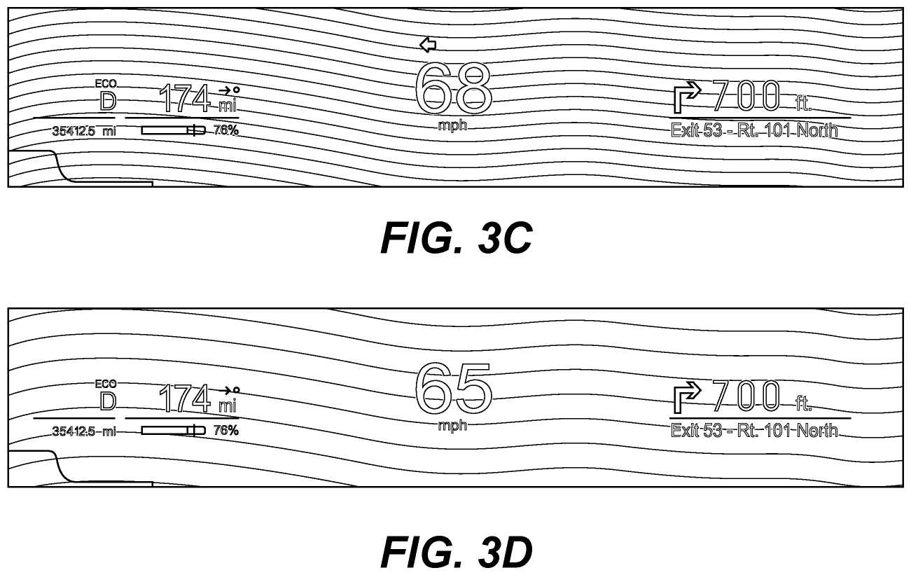

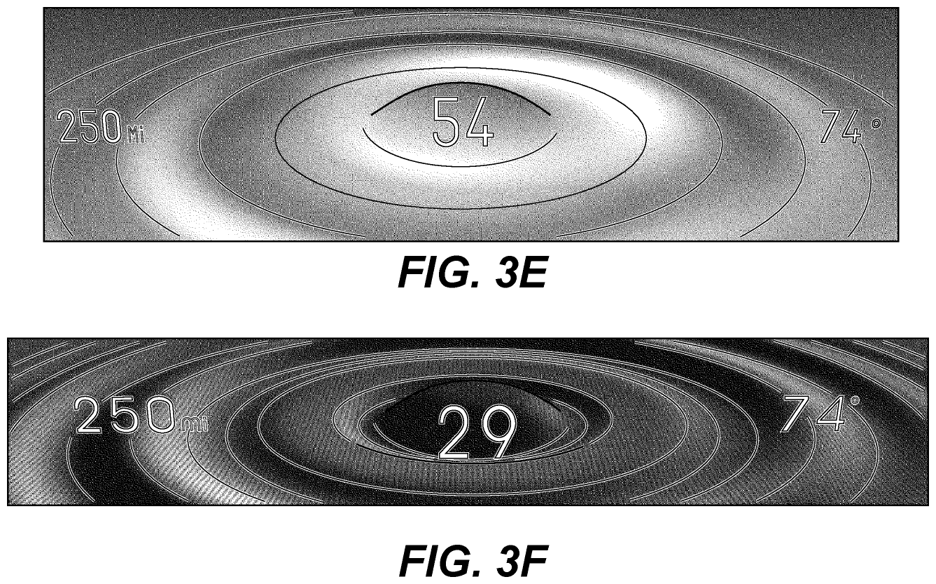

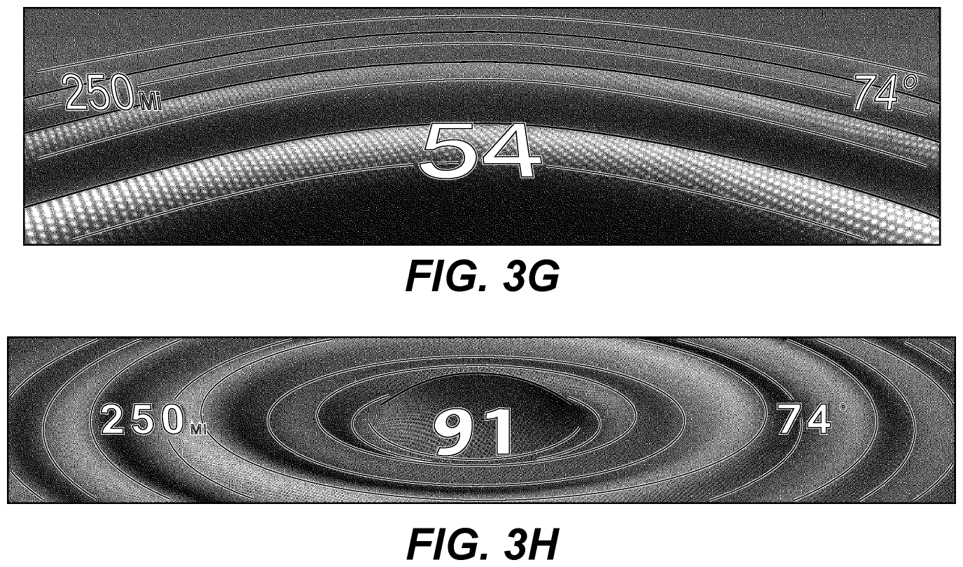

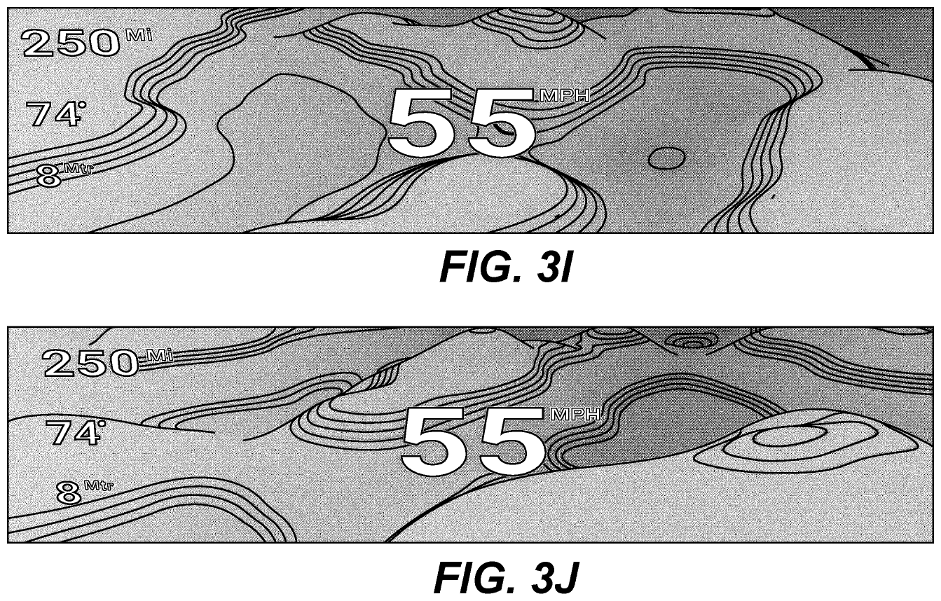

FIGS. 3A-3J illustrate exemplary aspects of sinusoidal waves consistent with the present disclosure. FIGS. 3A-3B illustrate graphical user interfaces including sinusoidal wave, indicators of state of vehicle or environment, and color that reflects charging or discharging. As illustrated in FIG. 3A, red color can indicate discharge of a battery (e.g., to a vehicle motor). As illustrated in FIG. 3B, green color may be based on charging of vehicle battery through regenerative braking or other charging function. The red and green colors are exemplary and other colors or other means for illustrating various vehicle states or characteristics may be used. As illustrated in FIG. 3C, one or more waves can be displayed as traveling across surface (e.g., from left to right). As illustrated in FIG. 3D, one or more waves can be displayed as traveling across surface (e.g., from upper left to lower right) in a mixture of colors. As illustrated in FIG. 3E, different portions of wave can be shown in different colors (e.g., one color for peak of wave and another color for valley of wave). As illustrated in FIG. 3F, wave can be displayed as textured. As illustrated in FIG. 3G, wave can be partially displayed (e.g., with waves extending from the view). As illustrated in FIG. 3H, wave can be displayed as textured and range of colors (e.g., one color for peak of wave and another color for valley of wave). As illustrated in FIGS. 3I-3J, one or more waves can be displayed with colored textures (e.g., around peaks and/or valleys).

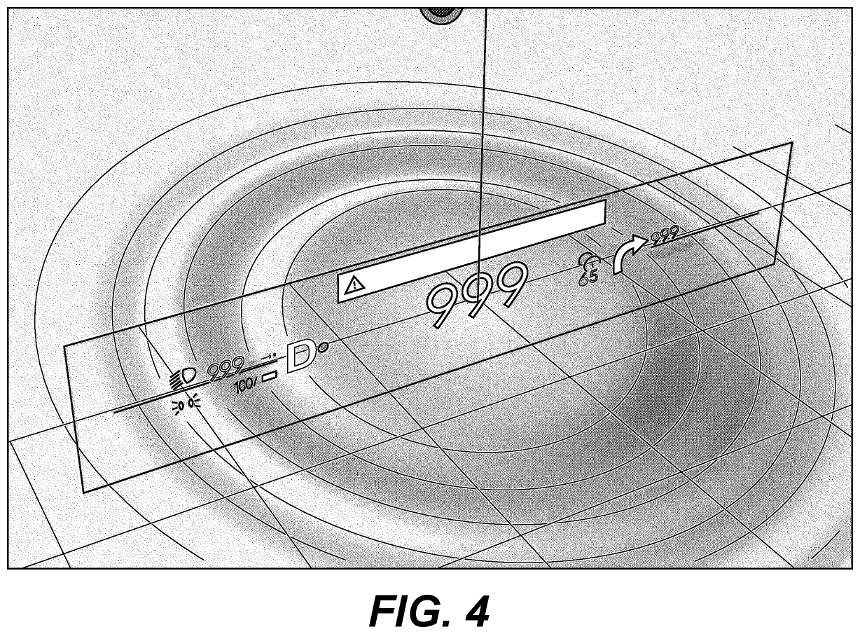

FIG. 4 illustrates an exemplary user graphic interface. User graphic interface of ripple may be displayed at an angle. For example, ripple may be shown in perspective view. Numerical or graphical data (e.g., elements such as speed of vehicle, outside temperature) may also be viewed at angle (e.g., as shown in FIG. 4) or in two-dimensional view (e.g., as shown in FIG. 1 or FIGS. 3A-3B).

It will be apparent to persons skilled in the art that various modifications and variations can be made to disclosed graphical, aural, and tactile user interfaces and screens. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A vehicle comprising:
a motor;
a screen;
a non-transitory computer storage medium configured to store computer-executable instructions;
one or more computer hardware processors in communication with the non-transitory computer storage medium, the one or more computer hardware processors configured to execute the computer-executable instructions comprising:
receiving one or more input associated with an energy usage of the vehicle;
determining a power consumption of the vehicle based on the input;
displaying a ripple on the screen, wherein an amplitude of the ripple is based on one or more vehicle characteristic and wherein a frequency of the ripple based on the power consumption.

2. The vehicle of claim 1, wherein the power consumption is based on at least one of acceleration, speed, environmental control, recharging, and use of one or more vehicle systems.

3. The vehicle of claim 1, wherein the one or more vehicle characteristic includes vehicle speed, vehicle acceleration, regenerative braking, and an efficiency.

4. The vehicle of claim 1, wherein a color of the ripple is based on a state of the vehicle.

5. The vehicle of claim 4, wherein the color of a ripple is based on whether the vehicle is recharging.

6. The vehicle of claim 1, wherein the instructions further comprise displaying directions associated with a navigation system.

7. The vehicle of claim 1, wherein the instructions further comprise displaying a state of a transmission of the vehicle.

8. The vehicle of claim 1, further comprising one or more speaker, wherein the instructions further comprise playing one or more sounds on the speaker based on the one or more vehicle characteristics.

9. The vehicle of claim 1, wherein the ripple is displayed at an angle.

10. A method for a graphical user interface, the method comprising:
receiving via a processor in a vehicle one or more input associated with an energy usage of the vehicle, wherein the vehicle comprises a motor, and a screen;
determining a power consumption of the vehicle based on the input; and
displaying a ripple on the screen, wherein an amplitude of the ripple is based one or more vehicle characteristic and wherein frequency of the ripple is based on the power consumption.

11. The method of claim 10, wherein the power consumption is based on at least one of acceleration, speed, environmental control, recharging, and use of one or more vehicle systems.

12. The method of claim 10, wherein the one or more vehicle characteristic includes vehicle speed, vehicle acceleration, regenerative braking, and an efficiency.

13. The method of claim 10, wherein a color of the ripple is based on a state of the vehicle.

14. The method of claim 13, wherein the color of a ripple is based on whether the vehicle is recharging.

15. The method of claim 10, wherein the instructions further comprise displaying directions associated with a navigation system.

16. The method of claim 10, wherein the instructions further comprise displaying a state of a transmission of the vehicle.

17. The vehicle of claim 10, further comprising one or more speaker, wherein the instructions further comprise playing one or more sounds on the speaker based on the one or more vehicle characteristics.

18. The method of claim 10, wherein the ripple is displayed at an angle.
